(19) United States
(12) Patent Application Publication
(10) Pub. No.: US 2021/0148704 A1
(43) Pub. Date: May 20, 2021

(54) MULTI-DIRECTIONAL MAGNETIC LEVELING DEVICE AND METHOD

(71) Applicant: Reginald Rice, Brandywine, MD (US)

(72) Inventor: Reginald Rice, Brandywine, MD (US)

(21) Appl. No.: 17/159,489

(22) Filed: Jan. 27, 2021

Related U.S. Application Data
(63) Continuation-in-part of application No. 16/012,746, filed on Jun. 19, 2018.
(60) Provisional application No. 62/522,068, filed on Jun. 19, 2017.

(51) Int. Cl. G01C 9/34

(52) U.S. Cl. CPC G01C 9/34; G01C 2009/187

(57) ABSTRACT

A leveling tool useful for determining levelness with multiple inclinations is disclosed herein. The leveling tool includes a level frame with four flat exterior faces placed against a workpiece, four transparent reservoirs containing fluid and air, and magnets integrated within the level frame. The reservoirs are oriented at angles of zero, 30, 45, and 90 degrees relative to one of the exterior faces, respectively. This variety of exterior faces and angled reservoirs allows the reservoirs to be used to indicate the level of a workpiece if the workpiece is oriented at any summation of zero, 30, 45, and 90 degrees of level. The magnets within the level frame allow the level frame to be removably coupled to a ferrous workpiece.

### CROSS-REFERENCE TO RELATED APPLICATIONS

The present application is related to and claims priority to U.S. Non-Provisional application Ser. No. 16/012,746, filed Jun. 19, 2018, is related to and claims priority to U.S. Provisional Patent Application No. 62/522,068 filed Jun. 19, 2017, both of which are incorporated by reference.

### BACKGROUND

The following includes information that may be useful in understanding the present disclosure. It is not an admission that the information provided is prior art nor material to the described or claimed inventions, nor that any publication or document expressly or implicitly referenced is prior art.

### TECHNICAL FIELD

The present invention generally relates to the field of hand tools and relates to leveling devices.

In construction and related fields, it is frequently desirable and necessary to orient structural members level with true horizontal. It may likewise be necessary to orient members at a particular angle to horizontal in other situations. Leveling in this way is necessary because it allows engineers and contractors to maintain reference points for making measurements and placing adjacent structural members.

Commonly, leveling tools are constructed to orient a member to either zero or 90 degrees from true horizontal. However, other angles are often needed in the construction industry, particularly for roof trusses, braces, railings, and similar structures. A suitable solution is desired.

U.S. Pat. No. 7,152,335 to Michael P. Nichols relates to an omnidirectional torpedo level having magnetic mounts and adjustable protractor. The described omnidirectional torpedo level having magnetic mounts and adjustable protractor includes an omnidirectional torpedo level composed of non-ferrous material having a central web and parallel side flanges defining a torpedo level geometry. The central web and side flanges define windows within which are mounted vertical and horizontal tubular spirit level elements that permit selective orientation of the side flanges to determine when surfaces being engaged by the side flanges are vertically or horizontally oriented. A rotary protractor is mounted to the central web and contains a spirit level tube for accurate positioning of the side flanges regarding the selected angle of the protractor.

### SUMMARY OF THE INVENTION

Given the preceding disadvantages inherent in the known leveling device art, the present disclosure provides a novel multi-directional magnetic leveling device and method. The present disclosure's general purpose, which will be described subsequently in greater detail, provides a multi-directional magnetic leveling device and method.

A leveling tool is disclosed.

### BRIEF DESCRIPTION OF THE DRAWINGS

The figures that accompany the written portion of this specification illustrate embodiments and methods of use for the present disclosure, a multi-directional magnetic leveling device and method, constructed and operative according to the present disclosure's teachings.

FIG. 1 is a perspective view of the leveling tool during an ‘in-use’ condition.

FIG. 2 is a perspective view of the leveling tool of FIG. 1.

FIG. 3 is an elevation of the leveling tool of FIG. 1.

FIG. 4 is a plan view of the leveling tool of FIG. 1.

FIG. 5 is a flow diagram illustrating a method of use for determining the levelness of a workpiece.

### DETAILED DESCRIPTION

Embodiments of the present disclosure relate to a leveling device and, more particularly, to a multi-directional magnetic leveling device and method

Generally, the leveling device is a multi-angle spirit level having magnets to attach to steel surfaces and structures. Including magnets enables individuals to level ferromagnetic objects in a hands-free manner quickly and easily. The leveling device has a cuboid body, with six faces related perpendicularly, making leveling from different sides of the level intuitive. The magnets may sit on multiple sides of the level, allowing users to attach the level to all metal surfaces from multiple sides. A preferred embodiment includes magnets positioned on all six sides of the cuboid body of the level. The leveling device is useful for craftspeople such as electricians, ironworkers, steamfitters, and metal stud workers, because it reduces the need to use both hands or more than one person to level an object. The cuboid level may measure approximately nine inches long, one and five-eighths inches tall, and five-eighths of an inch thick. The level may contain four glass level bulbs and nine magnets for attaching to a steel structure from any side. The four bulbs may be oriented at zero, 30, 45, and 90 degrees relative to one side of the level, respectively. The exact specifications may vary.

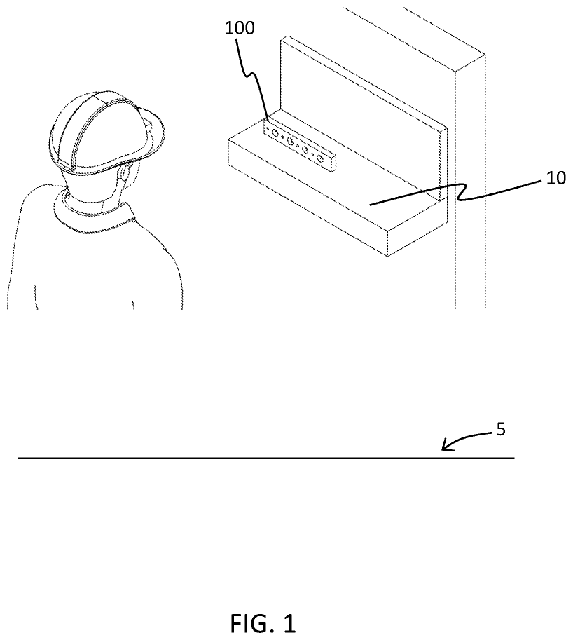

Referring now to the drawings by numerals of reference, FIGS. 1-4 show various views of a bubble level 100.

FIG. 1 shows a bubble level during an ‘in-use’ condition. Here, the bubble level may orient a member at the desired angle relative to the horizontal. As illustrated, bubble level 100 may be useful for measuring inclinations of a ferromagnetic surface 10 relative to a ground 5.

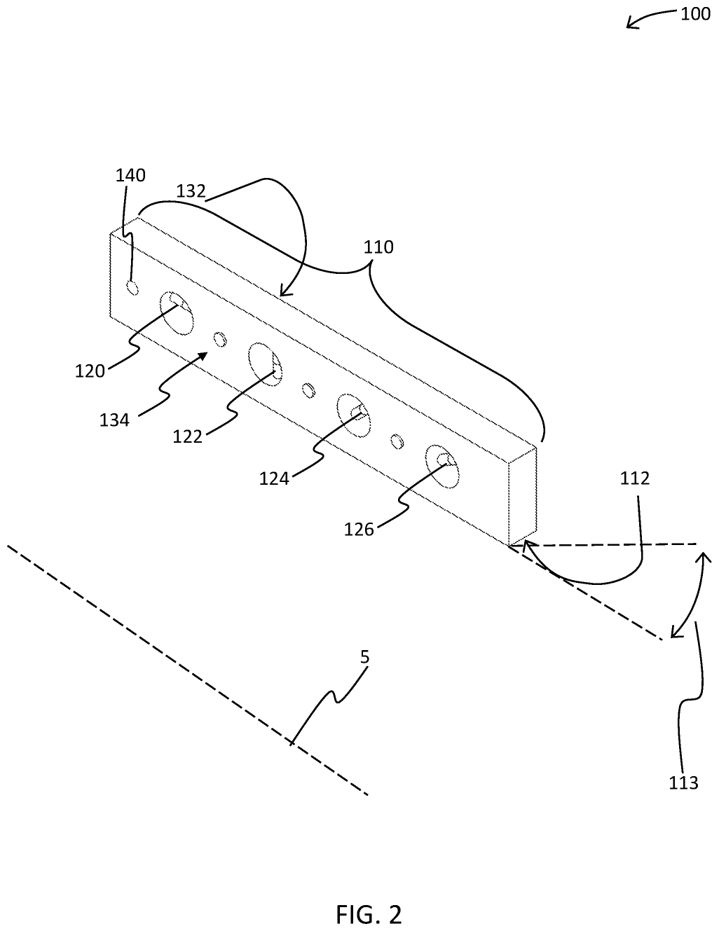

FIG. 2 shows the bubble level of FIG. 1. The bubble level 100 may include a frame 110, a horizontal bubble tube 120, a vertical bubble tube 122, a 45-degree bubble tube 124, a 30-degree bubble tube 126, and a 1st magnet 140. The level frame 110 may include a 1st flat surface 112, which may rest against the ferromagnetic surface 10 (FIG. 1), in which event the 1st flat surface 112 may define a 1st surface inclination 113. The horizontal bubble tube 120 may be fixed to the level frame 110 and may indicate when the 1st surface inclination 113 is horizontal. Likewise, the vertical bubble tube 122 may also be fixed to the level frame 110 and may indicate when the 1st surface inclination 113 is vertical. The 45-degree bubble tube 124 may be fixed to the level frame 110 and may indicate when the 1st surface inclination 113 is 45-degrees from the ground 5. The 30-degree bubble tube 126 may be fixed to the level frame 110 and may indicate when the 1st surface inclination 113 is 30-degrees from the ground 5 or horizontal. The horizontal bubble tube 120, the vertical bubble tube 122, the 45-degree bubble tube 124, and the 30-degree bubble tube 126 may be placed in a row linearly, such that all four may be viewed simultaneously by the user 40 (FIG. 1). Each of the horizontal bubble tube 120, the vertical bubble tube 122, the 45-degree bubble tube 124, and the 30-degree bubble tube 126 may be cylindrical and may have a transparent tubular sidewall defining an interior cavity containing fluid and air. And each of the horizontal bubble tube 120, the vertical bubble tube 122, the 45-degree bubble tube 124, and the 30-degree bubble tube 126 may further include indicia to indicate the deviation from level. The 1st magnet 140 may be fixed to the level frame 110 and may magnetically couple the ferromagnetic surface 10 (FIG. 1) to the 1st flat surface 112.

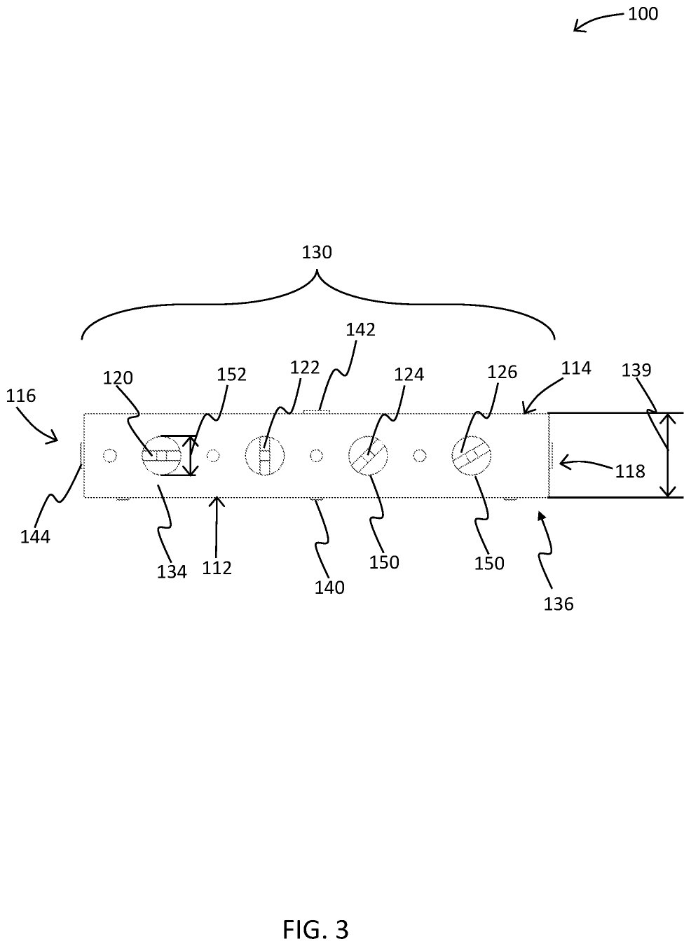

FIG. 3 is an elevation of the bubble level of FIG. 1. Preferably, the level frame 110 may be a cuboid 130. It may further include a 2nd flat surface 114, a 3rd flat surface 116, a 4th flat surface 118, each being configured to alternately rest against the ferromagnetic surface 10 (FIG. 1). The 1st flat surface 112, the 2nd flat surface 114, the 3rd flat surface 116, and the 4th flat surface 118 may be adjacently joined, and in a preferred embodiment may be joined perpendicularly. The bubble level 100 may further include additional magnets. The cuboid 130 of the level frame 110 may be substantially solid, and the level frame 110 may further include a plurality of apertures 150 extending through level frame 110. The horizontal bubble tube 120, the vertical bubble tube 122, the 45-degree bubble tube 124, and the 30-degree bubble tube 126 may each be positioned within one of the plurality of apertures 150. Preferably, each of the plurality of apertures 150 may be cylindrical and may have an aperture diameter 152 measuring three-quarters of an inch, respectively. The cuboid 130 may be defined by a height 139 measured between the 2nd flat surface 114 and the 4th flat surface 118. The height 139 may measure one and five-eighths inches in one embodiment.

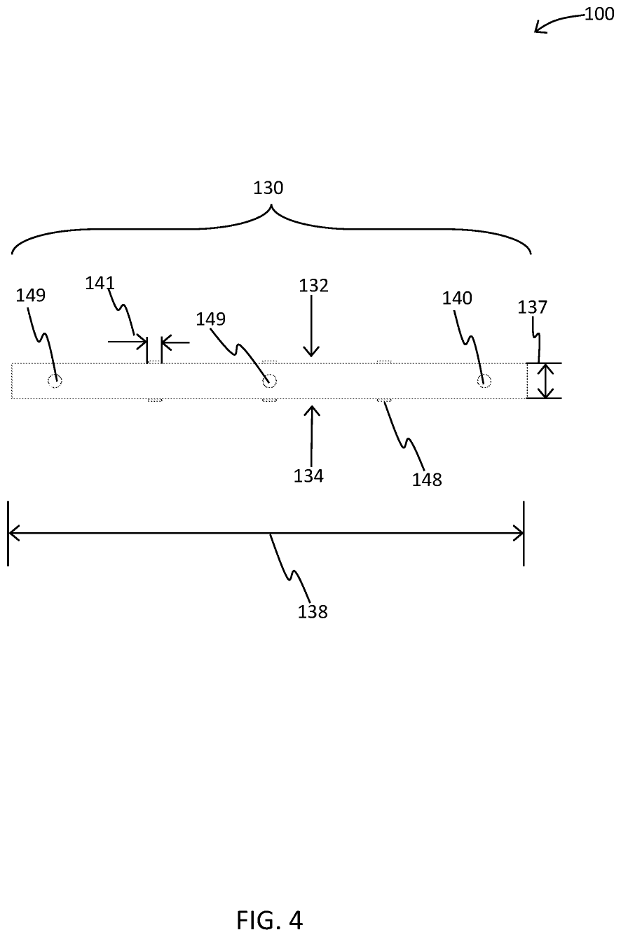

FIG. 4 is a top perspective view of the bubble level of FIG. 1. Cuboid 130 further includes a 2nd flat face 134, such that the 2nd flat face 134 may be opposite the 1st flat face 132. The 1st flat face 132 and the 2nd flat face 134 may be on opposite and parallel sides of the cuboid 130. A plurality of apertures 150 may extend between the 1st flat face 132 and the 2nd flat face 134. Further, the horizontal bubble tube 120 (FIG. 3), the vertical bubble tube 122 (FIG. 3), the 45-degree bubble tube 124 (FIG. 3), and the 30-degree bubble tube 126 (FIG. 3) may each be recessed between the 1st flat face 132 and the 2nd flat face 134. The 1st flat surface 112 (FIG. 3), the 2nd flat surface 114 (FIG. 3), the 3rd flat surface 116 (FIG. 3), and the 4th flat surface 118 (FIG. 3) may be adjacently joined and may define a rectangular perimeter 136 about the cuboid 130 between and the 1st flat face 132 and the 2nd flat face 134. As shown, the cuboid 130 may have a thickness 137 measured between the 1st flat face 132 and the 2nd flat face 134. In one embodiment, the thickness 137 may be five-eighths of an inch. The cuboid 130 may also have a length 138 measured between the 1st flat surface 112 and the 3rd flat surface 116. In one embodiment, the length 138 may be approximately nine inches. The 1st magnet 140, the 2nd magnet 142 (FIG. 3), the 3rd magnet 144 (FIG. 3), the 4th magnet (FIG. 3), and the 5th magnet 148 each include at least three evenly distributed magnets 149, respectively. In a preferred embodiment, the 1st magnet 140, the 2nd magnet 142 (FIG. 3), the 3rd magnet 144 (FIG. 3), the 4th magnet (FIG. 3), and the 5th magnet 148 may all be cylindrical and may each have a magnet diameter 141 measuring one-quarter of an inch.

In some versions, a level frame is a single-piece body that receives other level components. In some versions, configured to rest against the ferromagnetic surface means that the relationship between a bubble vial and that surface has been configured or calibrated to cause the bubble vial to indicate the orientation of the ferromagnetic object correctly when that surface lies on the ferromagnetic object. In some versions, the level comprises two sets of two parallel surfaces.

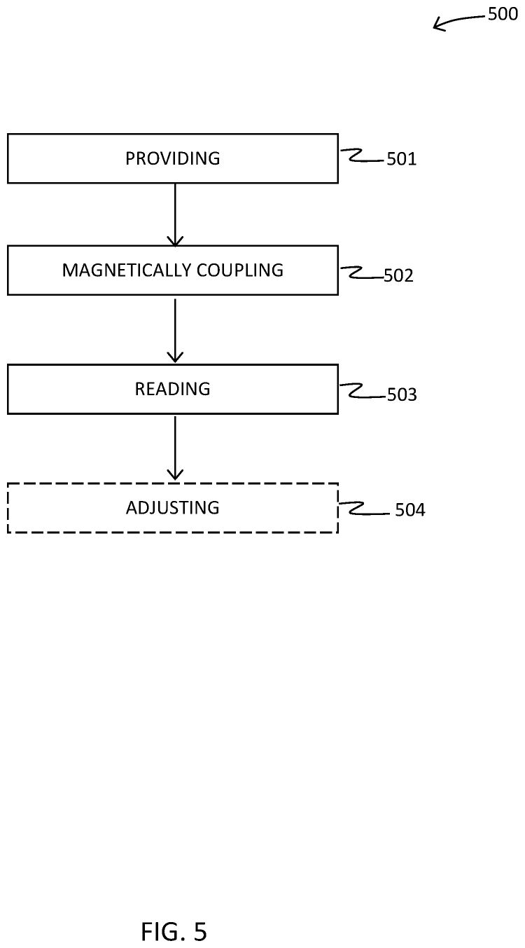

FIG. 5 is a flow diagram illustrating method 500 for determining the levelness of a workpiece. Method 500 may include one or more components or features of tool 100, as described above. As illustrated, the method 500 may include the steps of 501, providing a bubble level including a level frame including a 1st flat surface, the 1st flat surface being configured to rest against the ferromagnetic surface, the 1st flat surface defining a 1st surface inclination, a horizontal bubble tube fixed to the level frame and configured to indicate when the 1st surface inclination is horizontal, a vertical bubble tube fixed to the level frame and configured to indicate when the 1st surface inclination is vertical, a 45-degree bubble tube fixed to the level frame and configured to indicate when the 1st surface inclination is 45-degrees from the ground, a 30-degree bubble tube fixed to the level frame and configured to indicate when the 1st surface inclination is 30-degrees from the ground, and a 1st plurality of magnets fixed to the level frame and configured to magnetically couple the ferromagnetic surface to the 1st flat surface of the level frame; step 502, magnetically coupling the 1st flat surface to the workpiece; step 503, reading whether the horizontal bubble tube is level to the ground; and step 504, adjusting the workpiece until the horizontal bubble tube reads as horizontal to the ground.

Step 504 is optional and may not always be implemented. Optional steps of method 500 are illustrated using dotted lines in FIG. 5 to distinguish them from the other method steps.

What is claimed is:

1. A bubble level comprising a level frame including:
a 1st flat surface;
a 2nd flat surface;
a 3rd flat surface;
a 4th flat surface;
a 1st face;
a 2nd face;
a horizontal bubble tube fixed between the 1st and 2nd faces configured to indicate when the 1st and 2nd surfaces are horizontal and the 3rd and 4th surfaces are vertical;
a vertical bubble tube fixed between the 1st and 2nd faces and configured to indicate when the 1st and 2nd surfaces are vertical, and the 3rd and 4th surfaces are horizontal;
a 45-degree bubble tube fixed between the 1st and 2nd faces configured to indicate when the 1st, 2nd, 3rd, and 4th surfaces incline 45 or 135 degrees;
a 30-degree bubble tube fixed between 1st and 2nd faces and configured to indicate when the 1st and 2nd surfaces incline 30 degrees, and the 3rd and 4th surfaces incline 60 degrees;
and
a magnet fixed to or in each of the 1st-4th surfaces.

2. The bubble level of claim 1, wherein the 1st-4th surfaces are configured to rest against a ferromagnetic surface.

3. The bubble level of claim 2, wherein the level frame is a cuboid, the 1st face and the 2nd face define opposite sides of the cuboid, and the 1st, 2nd, 3rd, and 4th flat surfaces define a rectangular perimeter about the cuboid between the 1st face and the 2nd face.

4. The bubble level of claim 3, wherein the cuboid is substantially solid, and the level frame further includes a plurality of apertures extending through and between the 1st face and the 2nd face; and
wherein each of the horizontal bubble tube, the vertical bubble tube, the 45-degree bubble tube, and the 30-degree bubble tube are positioned within one of the plurality of apertures.

5. The bubble level of claim 4, wherein each of the horizontal bubble tube, the vertical bubble tube, the 45-degree bubble tube, and the 30-degree bubble tube are recessed between or flush with the 1st face and the 2nd face.

6. The bubble level of claim 5, wherein each of the plurality of apertures are cylindrical and have a ¾-inch aperture.

7. The bubble level of claim 6, wherein a magnet is embedded within the level frame, flush with the 1st flat surface.

8. The bubble level of claim 7, wherein the 1st-4th flat surfaces contain at least two additional magnets flush with a respective 1st-4th surface, and the set of magnets on the 1st flat surface is the 1st flat-surface-magnet set, the set of magnets on the 2nd flat surface is the 2nd flat-surface-magnet set, the set of magnets on the 3rd flat surface is the 3rd flat-surface-magnet set, and the set of magnets on the 4th flat surface is the 4th flat-surface-magnet set.

9. The bubble level of claim 8, wherein the cuboid has a 9-inch length measured between the 4th flat surface and the 3rd flat surface.

10. The bubble level of claim 9, wherein the cuboid has a 1⅝-inch height measured between the 2nd flat surface and the 1st flat surface.

11. The bubble level of claim 10, wherein the cuboid has a ⅝-inch thickness measured between the 1st and the 2nd face.

12. The bubble level of claim 11, further comprising a 5th magnet or magnet set fixed to the level frame and configured to magnetically couple the ferromagnetic surface to the 1st face.

13. The bubble level of claim 12, wherein the magnets of the 1st flat-surface-magnet set, 2nd flat-surface-magnet set, 3rd flat-surface-magnet set, 4th flat-surface magnet set, and face-magnet set are cylindrical and have a ¼-inch diameter.

14. A magnetic leveling device for measuring inclinations of a ferromagnetic surface comprising:
a level frame including a 1st flat surface, the 1st flat surface being configured to rest against the ferromagnetic surface, the 1st flat surface defining a 1st surface inclination;
a horizontal bubble tube fixed to the level frame and configured to indicate when the 1st surface inclination is horizontal;
a vertical bubble tube fixed to the level frame and configured to indicate when the 1st surface inclination is vertical;
a 45-degree bubble tube fixed to the level frame and configured to indicate when the 1st surface inclination is 45 degrees;
a 30-degree bubble tube fixed to the level frame and configured to indicate when the 1st surface inclination is 30 degrees;
and
a 1st flat-surface magnet set is embedded within the level frame, flush with the 1st flat surface,
wherein the level frame is a cuboid and further includes a 2nd flat surface, a 3rd flat surface, a 4th flat surface, a 1st face, and a 2nd face, each configured to rest against the ferromagnetic surface, the 1st face and the 2nd face defining opposite sides of the cuboid and the 1st, 2nd, 3rd, and 4th flat surfaces defining a rectangular perimeter about the cuboid between the 1st and the 2nd faces,
further comprising:
a 2nd flat-surface magnet set disposed flush with the 2nd flat surface and configured to magnetically couple the ferromagnetic surface to the 2nd flat surface;
a 3rd flat-surface magnet set disposed flush with the 3rd flat surface and configured to magnetically couple the ferromagnetic surface to the 3rd flat surface;
a 4th flat-surface magnet set disposed flush with the 4th flat surface and configured to magnetically couple the ferromagnetic surface to the 4th flat surface;
and
a face magnet set disposed flush with the 1st face and configured to magnetically couple the ferromagnetic surface to the 1st face,
wherein the cuboid is substantially solid, and the level frame further includes a plurality of apertures extending through and between the 1st face and the 2nd face;
wherein each of the horizontal bubble tube, the vertical bubble tube, the 45-degree bubble tube, and the 30-degree bubble tube are positioned within one of the plurality of apertures;
wherein each of the horizontal bubble tube, the vertical bubble tube, the 45-degree bubble tube, and the 30-degree bubble tube are recessed between or flush with the 3rd flat surface and the 4th flat surface;
wherein some of the plurality of apertures are cylindrical and have a ¾-inch diameter;
wherein the cuboid has a 9-inch length measured between the 4th flat surface and the 3rd flat surface;
wherein the cuboid has a 1⅝-inch height measured between the 2nd flat surface and the 1st flat surface;
wherein the cuboid has a 1⅝-inch thickness measured between the 1st face and the 2nd face;
and
wherein the magnets of the 1st flat-surface-magnet set, the 2nd flat-surface-magnet set, the 3rd flat-surface-magnet set, the 4th flat-surface magnet set, and the face magnet set are all cylindrical and have a ¼-inch diameter.

15. A method comprising the steps of
providing a bubble level including a level frame including
a 1st flat surface, defining a 1st surface inclination;
a 2nd flat surface;
a 3rd flat surface;
a 4th flat surface;
a 1st face;
and
a 2nd face;
a horizontal bubble tube fixed between the 1st face and the 2nd face configured to indicate when the 1st surface inclination is horizontal;
a vertical bubble tube fixed between the 1st face and the 2nd face and configured to indicate when the 1st surface inclination is vertical;
a 45-degree bubble tube fixed between the 1st face and the 2nd face and configured to indicate when the 1st surface inclination is 45 degrees;
a 30-degree bubble tube fixed between the 1st face and the 2nd face and configured to indicate when the 1st surface inclination is 30 degrees;
and
a 1st flat-surface magnet set disposed flush with the 1st flat surface and configured to magnetically couple the ferromagnetic surface to the 1st flat surface,
wherein each surface and face is configured to rest against the ferromagnetic surface,
and
reading the horizontal bubble tube.

16. The method of claim 15 further comprising the step of adjusting the workpiece until the horizontal bubble tube indicates horizontal.
